(19) United States
(12) Patent Application Publication
(10) Pub. No.: US 2016/0357456 A1
(43) Pub. Date: Dec. 8, 2016

(54) MEMORY DEVICE THAT DIVIDES WRITE DATA INTO A PLURALITY OF DATA PORTIONS FOR DATA WRITING

(71) Applicant: KABUSHIKI KAISHA TOSHIBA, Tokyo (JP)

(72) Inventor: Kiyotaka IWASAKI, Kawasaki Kanagawa (JP)

(21) Appl. No.: 15/063,431

(22) Filed: Mar. 7, 2016

Related U.S. Application Data
(60) Provisional application No. 62/170,422, filed on Jun. 3, 2015.

(51) Int. Cl. G06F 3/06

(52) U.S. Cl. CPC G06F 3/0613; G06F 3/0644; G06F 3/0658; G06F 3/0659; G06F 3/0679

(57) ABSTRACT

A memory device includes a nonvolatile memory unit including a plurality of banks, and a memory controller. The memory controller is configured to divide write data received from a host into a plurality of data portions, and with respect to each of the data portions, determine a bank in which said data portion is to be written and generate a write command to write said data portion to the determined bank. The memory controller determines the bank in which each of the data portions is to be written, based on the number of write commands queued for each of the banks.

### CROSS-REFERENCE TO RELATED APPLICATION

This application is based upon and claims the benefit of priority from U.S. Provisional Patent Application No. 62/170,422, filed Jun. 3, 2015, the entire contents of which are incorporated herein by reference.

### FIELD

Embodiments described herein relate generally to a memory device, in particular, a memory device that divides write data into a plurality of data portions for data writing.

### BACKGROUND

In the related art, a memory device includes a nonvolatile memory unit and a memory controller that controls access to the nonvolatile memory unit.

### BRIEF DESCRIPTION OF THE DRAWINGS

FIG. 1 is a perspective view of an information processing system according to a first embodiment.

FIG. 2 is a block diagram of a memory system according to the first embodiment.

FIG. 3 is a block diagram of a write-location determination unit in the memory system according to the first embodiment.

FIG. 4 is a write-location management table stored in the memory system according to the first embodiment.

FIG. 5 illustrates an example of counter values of a running-command counter CT0 in a memory controller of the memory system according to the first embodiment.

FIG. 6 is a flow chart of a write-location determination process carried out in the memory system according to the first embodiment.

FIG. 7 is a timing chart of bank interleaving carried out in the memory system according to the first embodiment.

### DETAILED DESCRIPTION

In general, according to an embodiment, a memory device includes a nonvolatile memory unit including a plurality of banks, and a memory controller. The memory controller is configured to divide write data received from a host into a plurality of data portions, and with respect to each of the data portions, determine a bank in which said data portion is to be written and generate a write command to write said data portion to the determined bank. The memory controller determines the bank in which each of the data portions is to be written, based on the number of write commands queued for each of the banks.

Embodiments will be described hereinafter with reference to the accompanying drawings. In the following description, one same reference number or a set of symbols is assigned to functions or elements which are substantially identical, and description is given as necessary. In the specification of the present application, more than two names or technical terms are given to some of the elements. These names and terms are merely examples, and are in no way restrictive.

### First Embodiment

[1. Configuration]

[1-1. Overall Configuration (Information Processing System)]

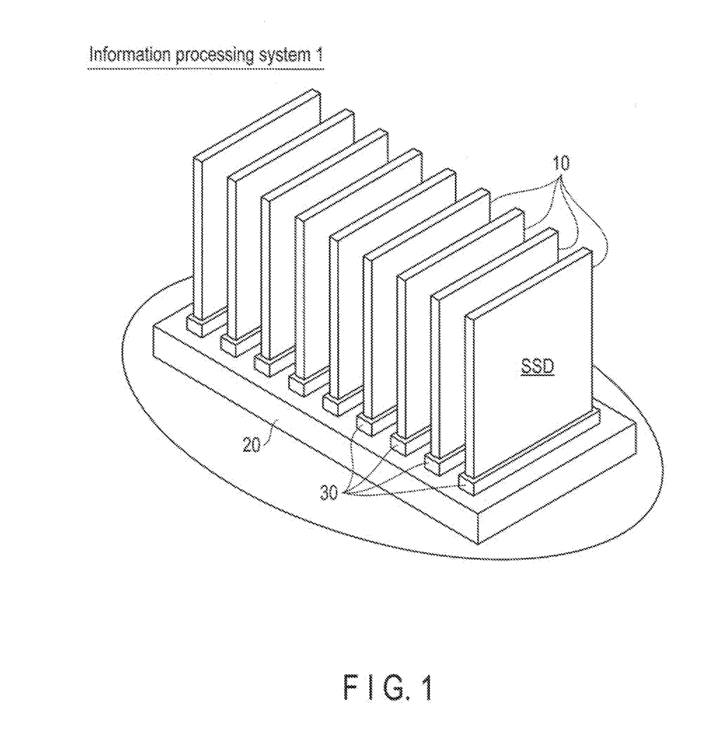

Referring to FIG. 1, an information processing system 1 according to a first embodiment is described. As shown, the information processing system 1 according to the first embodiment includes a memory system 10 and a host 20 which controls the memory system 10. In the present embodiment, a solid-state drive (SSD) is used in the description as an example of the memory system 10.

As shown in FIG. 1, the SSD 10, which is the memory system according to the first embodiment, is a comparatively small module, for example. An example of the external dimensions of the SSD 10 is approximately 100 mm x 150 mm; however, the size and exterior dimensions of the SSD 10 are not limited to this size.

The SSD 10 can be used by being mounted in a server-like host 20, in a data center, a cloud computing system, or the like, which are operated in an enterprise. Thus, the SSD 10 may be an enterprise SSD (eSSD).

The host (host device) 20 includes, for instance, a plurality of connectors (such as slots) 30 of which apertures face upward. Each connector 30 is, for example, a Serial Attached SCSI (SAS) connector. By utilizing this SAS connector with 6-Gbps dual ports, the host 20 and each SSD 10 can perform high speed communication. However, each connector 30 is not limited to be an SAS connector, and may be a PCI Express (PCIe), Serial ATA (SATA), or the like.

Further, the SSDs 10 are mounted to the connectors 30 of the host 20 respectively, to be held and supported side by side with each other, in an upright position in a substantially vertical direction. This structure enables a plurality of SSDs 10 to be compactly mounted, and to downsize the host device 20. Each SSD 10 according to the present embodiment is a 2.5 inch small form factor (SFF). Such a shape allows the SSD 10 to be compatible with an enterprise HDD (eHDD) in shape, and provides an easy system compatibility with an enterprise HDD (eHDD).

The SSD 10 is not limited for enterprises. For example, the SSD 10 is of course applicable to a storage medium of a consumer electronic device such as a notebook portable computer or a tablet terminal.

[1-2. Memory System]

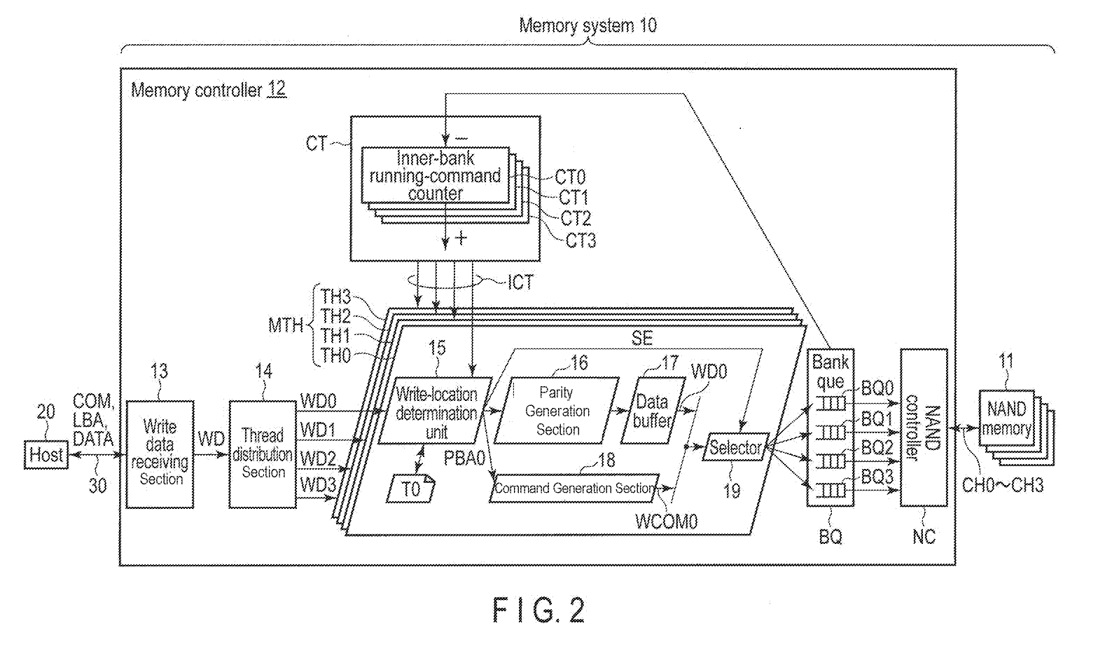

Referring to FIG. 2, the configuration of the memory system (SSD) 10 according to the first embodiment is described in detail. As shown, the memory system 10 according to the first embodiment includes a NAND flash memory (hereinafter referred to as a ‘NAND memory’) 11 and a memory controller 12 which controls the NAND memory 11.

[NAND Memory 11]

The NAND memory 11 is a semiconductor memory which includes a plurality of blocks and operative to store data, with non-volatility, in each block. The NAND memory 11 stores write data WD transmitted from the host 20 in those blocks in accordance with control by the memory controller 12, and reads the stored data from the blocks. Also, the NAND memory 11 erases the data stored in the blocks in accordance with the control by the memory controller 12.

A block (physical block) includes a plurality of memory cell units arranged in a direction of word lines. Each cell unit includes the following: a NAND string (memory cell string) consisting of a plurality of memory cells connected in series and extending in a direction of bit lines which intersect with the word lines; a select transistor on the source side, i.e., one end of the NAND string; and a select transistor on the drain side, i.e., the other end of the NAND string. Each memory cell MC includes a control gate CG and a floating gate FG. The other ends of the current pathways of the select transistors on the source side are connected to a source line in common. The other ends of the current pathways of the select transistors on the drain side are connected to a corresponding bit line.

The word lines are connected to the control gates of the memory cells MC arranged along the word line in common. A page is allocated in each word line. Data read/data write operations are performed on a page-by-page basis. Thus, a page is a unit of data read/write. In contrast, data erase operation is performed collectively on a block-by-block basis. Therefore, a block is a unit of data erase.

Each of the memory cells MC of the NAND memory 11 according to the first embodiment is a multi-level cell (MLC) which can store multibit data. In this instance, a quad memory is used as an example of an MLC. However, the NAND memory 11 is not limited to be a quad memory, and may be an octal memory, a hex memory, or the like. Moreover, each of the memory cells MC of the NAND memory 11 according to the first embodiment may be a single-level cell (SLC) which can store one-bit data.

[Memory Controller 12]

The memory controller (controller, or memory control unit) 12 controls the NAND memory 11 on the basis of a command COM transmitted from the host 20, a logical address LBA, data DATA, and the like. The memory controller 12 includes a write data receiving section 13, a thread distribution section 14, a plurality of threads TH0-TH3, a bank queue BQ, a counter CT, and a NAND controller NC. As described above, the memory controller 12 is a multi-thread structure (MTH) including a plurality of threads TH0-TH3.

The write data receiving section 13 is provided between the host 20 and the memory system 10, and receives the write data WD transmitted from the host 20. The write data receiving section 13 may also exchange a logical address LBA or read data RD with the host 20 in addition to the write data WD.

The thread distribution section 14 distributes write data WD transmitted from the write data receiving section 13 to each of the plurality of threads TH0-TH3 as write data WD0-WD3. The thread distribution section 14 distributes write data WD, for example, on the basis of the seriality of the logical address LBA transmitted from the host 20 or the like. Thus, the distributed write data WD0-WD3 includes a part or the whole of the write data WD transmitted from the host 20.

Each of the plurality of threads TH0-TH3 determines a write-location in the NAND memory 11 in which the distributed write data WD0-WD3 are to be written, and transmits the determined write-location with a command and the like appended to the bank queue BQ. Thus, there is no exchange of data such as write data WD0-WD3 among the threads TH0-TH3, and thus each of the threads TH0-TH3 is configured to process data independently.

However, each of the threads TH0-TH3 dynamically determines the write-location on the basis of command progress information ICT of all threads TH0-TH3, which includes the numbers of running-commands in the banks fed back from a corresponding one of the counters CT0-CT3. For example, the thread TH0 dynamically determines the write-location on the basis of, at least, command progress information ICT of all threads TH0-TH3, which includes the numbers of running-commands in the banks fed back from the counter CT0. The write-locations determined by a plurality of threads TH0-TH3 are transmitted to the bank queue BQ with a write command. The threads TH0-TH3 will be described in detail below.

The bank queue BQ queues commands (for example, write commands WCOM0-WCOM3) transmitted from the plurality of threads TH0-TH3. The bank queue BQ includes four bank queues BQ0-BQ3. The bank queues BQ0-BQ3 correspond to four banks, and each of the bank queues BQ0-BQ3 includes a plurality of logical blocks. Each of the four bank queues BQ0-BQ3 queues a write command and the like. Each of the bank queues BQ0-BQ3 has a first-in first-out (FIFO) data structure in which data input to the bank first will be output first.

The counter CT (CT0-CT3) is configured to increment (+) a counter value when any one of the threads TH0-TH3 determines a write-location, and to decrement (−) the value when a process of writing data to the NAND memory 11 completes. To be more precise, when a write command is queued to one of the bank queues BQ0-BQ3, the counter CT increments (+) the number of commands (queued commands) held in the bank queue to which the write command was queued. Meanwhile, when a write command is de-queued from the bank queue, the counter CT decrements (−) the number of commands (queued commands) held in the bank queue from which the command was de-queued. The counter CT will be described in detail below.

The NAND controller NC accesses the NAND memory 11 and controls data write/read operations and the like. Via a plurality of channels (in this instance, four channels CH0-CH3), the NAND controller NC writes the write data WD0-WD3 to the NAND memory 11, in parallel, on the basis of the write commands WCOM0-WCOM3 transmitted from the bank queue BQ. The plural-channel structure above enables write data WD0-WD3 to be written to the NAND memory 11 within a predetermined permissible time.

However, the configuration of the memory controller 12 described above is an example, and is not the only configuration. For example, the memory controller 12 may control the above components (13, 14, MTH, BQ, CT, and NC) via a predetermined control line, and may include a control unit which controls the whole operation of the memory controller 12. Such a control unit may be, for example, a central processing unit (CPU) or the like.

[Thread TH]

The threads TH0-TH3 included in the multi-thread MTH constitution is described below. Here, a thread TH0 shown in FIG. 2 is described as an example.

The thread TH0 includes a write-location determination unit 15, a write-location management table T0, a parity generation section 16, a data buffer 17, a command generation section 18, and a selector 19.

The write-location determination unit 15 receives the write data WD0 distributed by the thread distribution section 14. The write-location determination unit 15 refers to the management table T0, receives a feedback from the counter CT, and determines write-location information PBA0 in the NAND memory in which the write data WD0 is to be written. Furthermore, the write-location determination unit 15 generates a select signal SE to queue the write data WD0 and the write command WCOM0 on the basis of the determined write-location information PBA0, and transmits the generated select signal SE to the selector 19. The write-location determination unit 15 will be described in detail below.

The write-location management table T0 indicates a progress status of write operations in each page (page 0-n) in the four banks (Bank 0-3) of the NAND memory 11, each of which is composed of logical blocks. For example, the write-location management table T0 indicates the progress status of write operations in each page (page 0-n) in the four banks (Bank 0-3) by a predetermined flag bit FLB. The write-location management table T0 will be described in detail below.

The inner-logical-page parity generation section 16 receives the write data WD0 from the write-location determination unit 15, and generates a predetermined parity bit from the received write data WD0. For example, the parity generation section 16 generates a parity bit which indicates whether the number of bits having a value of “1” in a bit line composing the write data WD0 is even or odd. For example, the value of the generated parity bit is set to “1” when the number of bits having the value of “1” is odd, and set to “0” when the number of bits having the value of “1” is even (=even parity). The generated parity bit is appended to the write data WD0. The controller 12 determines whether or not the write data WD0 includes an error by determining whether the value of the appended parity bit indicates matches the number of bits having the value of “1” (even/odd) in the write data WD0.

The data buffer 17 stores the write data WD0 with the appended parity bit transmitted from the parity generation section 16. For example, the data buffer 17 stores data until the data size of the write data WD0 reaches to a predetermined size that is suitable to write to the NAND memory 11. The data buffer 17 stores data until the data size of the write data WD0 reaches to, for example, 16 KB, which is the size of a page.

The command generation section 18 generates a predetermined command on the basis of the write-location information PBA0 generated by the write-location determination unit 15. For example, the command generation section 18 generates a write command WCOM0 on the basis of the write-location information PBA0 of the write data WD0, which is generated by the write-location determination unit 15.

The selector 19 selects one of the bank queues BQ0-BQ3 in which the write data WD0 and the write command WCOM0 are queued, on the basis of the select signal SE.

The configuration of the other threads TH1-TH3 is substantially identical to one of the above-described thread TH0. Therefore, no detailed description of those threads is given.

[1-3. Write-location Determination Unit 15]

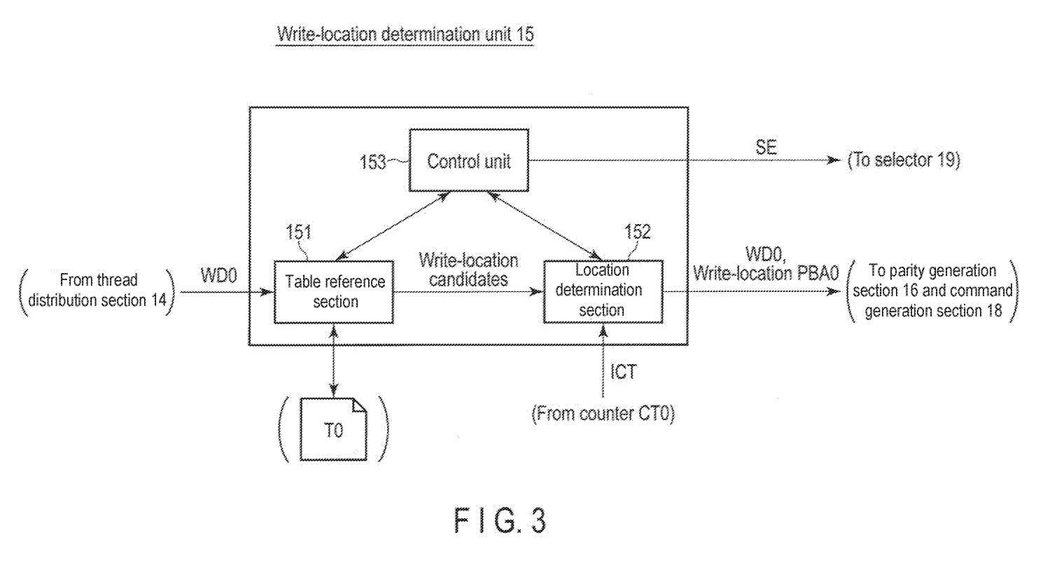

Referring to FIG. 3, the write-location determination unit 15 according to the first embodiment is described in detail. As shown, the write-location determination unit 15 according to the first embodiment includes a table reference section 151, a location determination section 152, and a control unit 153.

The table reference section 151 receives the write data WD0 distributed from the thread distribution section 14. The table reference section 151 then refers to the management table T0, and transmits write-location candidates of the received write data WD to the location determination section 152, which is determined on the basis of the management table T0.

On the basis of the command progress information ICT of threads TH0-TH3 which is fed back from counter CT0, the location determination section 152 determines a write-location of the write data WD0 out of the received write-location candidates. The location determination section 152 then transmits the determined write-location to the parity generation section 16 and the command generation section 18 as a location information (for example, a physical address) PBA0 of the write data WD0.

The control unit 153 controls the table reference section 151 and the location determination section 152, and controls the whole operation of the write-location determination unit 15. Moreover, on the basis of the determined location information PBA0, the control unit 153 generates a select signal SE to queue the write data WD0 and the write command WCOM0 to one of the bank queues BQ0-BQ3.

[1-4. Write-location Management Table T0]

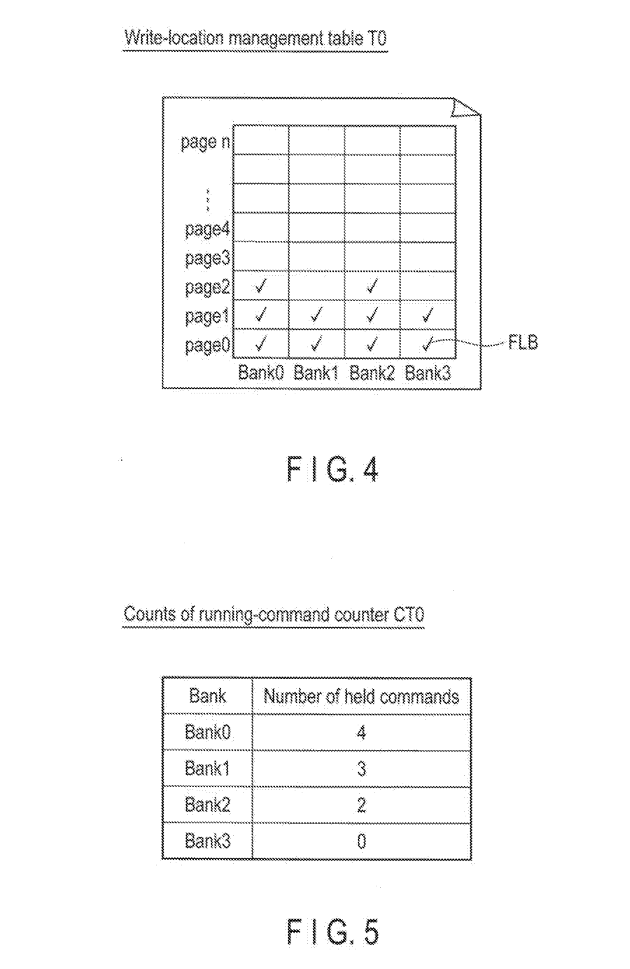

Referring to FIG. 4, an example of detailed configuration of the write-location management table (hereinafter referred to as a “table”) T0 included in the thread TH0 according to the first embodiment is be described.

As shown in FIG. 4, in the table T0 according to the first embodiment, presence/absence of writing in each page (page 0-n) in the four banks (Bank 0-3) is indicated by a flag bit FLB.

The flag bit FLB indicates, for example, that writing on a page has been executed by setting a flag bit (“1 state”=FLB1) (checked state in the table T0). For example, in FIG. 4, flag bits are set to page 0-2 of Bank 0 and Bank 2, and page 0-1 of Bank 1 and Bank 3, which indicate that writing on those pages have been executed.

On the other hand, the flag bit FLB indicates, for example, that writing on a page is has not been executed by not setting a flag bit (“0 state”=FLB0) (unchecked state in the table T0). For example, in FIG. 4, absence of flag bits indicates that writing on those unchecked pages has not been executed.

The tables included in the other threads TH1-TH3 are substantially identical to the table of the above-described thread TH0. Therefore, no detailed description of them is given.

[1-5. Counts of Counter CT0]

Referring to FIG. 5, a count indicated in a running-command counter CT according to the first embodiment is described in detail. Here, a count of counter CT0 is described as an example.

As shown in FIG. 5, the counter CT0 indicates the total number of commands (command information) which were input from its own thread TH0 and the other threads TH0-TH3, to each bank (Bank 0-3). The commands are, for example, the write commands WCOM0-WCOM3 and the like. For example, the numbers of commands input to Bank 0-3 are “4”, “3”, “2”, and “0”, respectively. These numbers correspond to the number of commands queued, that is, pending commands that has not been executed, and the number of commands basically corresponds to a queue delay.

To be more precise, the counter CT0 counts the number of commands input from the command generation section 18 to each of the bank queues BQ0-BQ3. The counter CT0 feeds (informs/transmits) the counts back to the location determination section 152 of the write-location determination unit 15 in the thread TH0 as command progress information ICT. For example, the counter CT0 feeds the counts indicated in FIG. 5 back to the location determination section 152 as the command progress information ICT.

The counters CT1-CT3 corresponding to the other threads TH1-TH3, respectively, are substantially identical to the above-described counter CT0. Therefore, no detailed description of them is given.

[2. Operation]

Next, the operation of the memory system 10 according to the first embodiment is described.

[2-1. Write-location Determination Process]

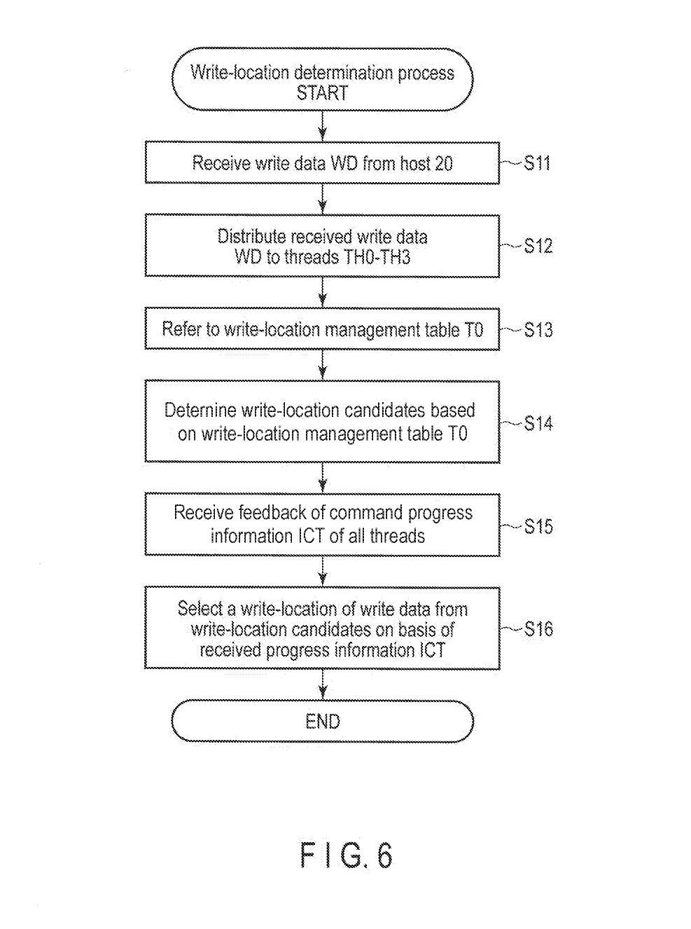

Referring to FIG. 6, a process to determine the write-location carried out in the memory system 10 according to the first embodiment is described. Here, the operation of the thread TH0 is described as an example.

In step S11, the memory controller 12 receives write data WD from the host 20. To be more precise, the write data receiving section 13 of the memory controller 12 receives write data WD transmitted from the host 20.

In step S12, the memory controller 12 distributes the received write data WD to one of the threads TH0-TH3. To be more precise, the thread distribution section 14 of the memory controller 12 distributes the received write data WD to the plurality of threads TH0-TH3 as write data WD0-WD3, respectively, on the basis of the seriality of the logical address LBA or the like.

In step S13, the memory controller 12 refers to the write-location management table T0. To be more precise, the table reference section 151 of the thread TH0 included in the memory controller 12 refers to the table T0.

In step S14, the memory controller 12 determines write-location candidates on the basis of the write-location management table T0. To be more precise, the table reference section 151 of the thread TH0 included in the memory controller 12 determines write-location candidates of the write data WD0 on the basis of the table T0. For example, in case of the table T0 shown in FIG. 4, the table reference section 151 determines Bank 1 and Bank 3, which include less written pages (page 0-1), as the write-location candidates. The determined write-location candidates (Bank 1 and Bank 3) of the write data WD0 are transmitted to the location determination section 152.

In step S15, the memory controller 12 receives command progress information ICT of all threads TH0-TH3. To be more precise, the counter CT0 of the thread TH0 included in the memory controller 12 counts the numbers of commands input from the command generation section 18 to each of the bank queues BQ0-BQ3. The counter CT0 feeds (informs/transmits) the counts back to the location determination section 152 of the write-location determination unit 15, as the command progress information ICT. For example, the counter CT0 feeds the counts (Bank 0: 4, Bank 1: 3, Bank 2: 2, Bank 3: 0) shown in FIG. 5 back to the location determination section 152, as the command progress information ICT.

In step S16, the memory controller 12 selects a write-location of the write data WD0 from the write-location candidates determined in step S14, on the basis of the received progress information ICT, and ends this operation. To be more precise, the table reference section 151 of the thread TH0 included in the memory controller 12 selects a write-location of the write data WD0 from the write-location candidates, on the basis of the received progress information ICT. For example, on the basis of the progress information ICT (Bank 0: 4, Bank 1: 3, Bank 2: 2, Bank 3: 0), the table reference section 151 selects Bank 3 (number of command(s): 0) which holds less commands than Bank 1 (number of command(s): 3), out of the write-location candidates (Bank 1 and Bank 3) selected in step S14, as the write-location of the write data WD0. The selected write-location is transmitted to the parity generation section 16 and the command generation section 18 as location information (for example, a physical address, or the like) PBA0.

On the basis of the location information PBA0, the control unit 153 of the write-location determination unit 15 generates a select signal SE to queue the write data WD0 and the write command WCOM0 to one of the bank queues BQ0-BQ3. For example, the control unit 153 transmits the generated select signal SE to the selector 19, and queues the write data WD0 and the write command WCOM0 to the selected bank queues BQ3.

The write-location determination operations of the other threads TH1-TH3 are substantially identical to the one of the thread TH0. Therefore, no detailed description of them is given.

[3. Advantageous Effects]

As described above, utilizing the configuration and operation of the memory system 10 according to the first embodiment, there at least two merits (1) and (2) listed below.

(1) The write time required to write the received write data to the NAND memory 11 can be reduced.

The write time is described below by comparing the first embodiment with a comparative example.

### A) Comparative Example

A memory system according to the comparative example is a multi-thread constitution similar to the first embodiment. The memory system according to the comparative example writes write data to a write-location in a NAND memory, which is determined by each thread without referring to the progress status of write operations in each page (page 0-n) in the four banks. In other words, a thread in the memory system according to the comparative example determines a write-location without considering the operating states of threads other than itself.

Thus bank interleaving may not function properly, and it is likely to take a longer time in writing the data to the NAND memory. In this regard, “bank interleave” refers to the operation of writing in a different bank in a ready state when one bank is in a busy state.

To be more precise, in the memory system according to the comparative example, one thread statically determines the write-location without considering the operating states of threads other than itself, according to a predetermined schedule or the like. Thus, for example, when one thread queues write data to Bank 0 and Bank 1, there are possibilities that the other threads also queue write data to Bank 0 and Bank 1. In such a case, writing operations are concentrated on the Bank 0 and Bank 1, and thus bank interleaving may not function properly. As a result, it is likely to take a longer time in writing data.

As described above, the memory system according to the comparative example has a demerit in reducing the write time because the bank interleaving may not function properly.

### B) First Embodiment

Compared to the comparative example, the memory system 10 according to the first embodiment includes at least a counter CT which counts the numbers of commands input from the all threads TH0-TH3 to each of the bank queues BQ0-BQ3, and determines the write-location of the write data WD0 on the basis of the command progress information ICT fed back from the counter CT (FIG. 2).

As described above, the memory system 10 according to the first embodiment dynamically evaluates the operating states of the all threads TH0-TH3, and determines the write-location of the write data WD0 in the NAND memory 11.

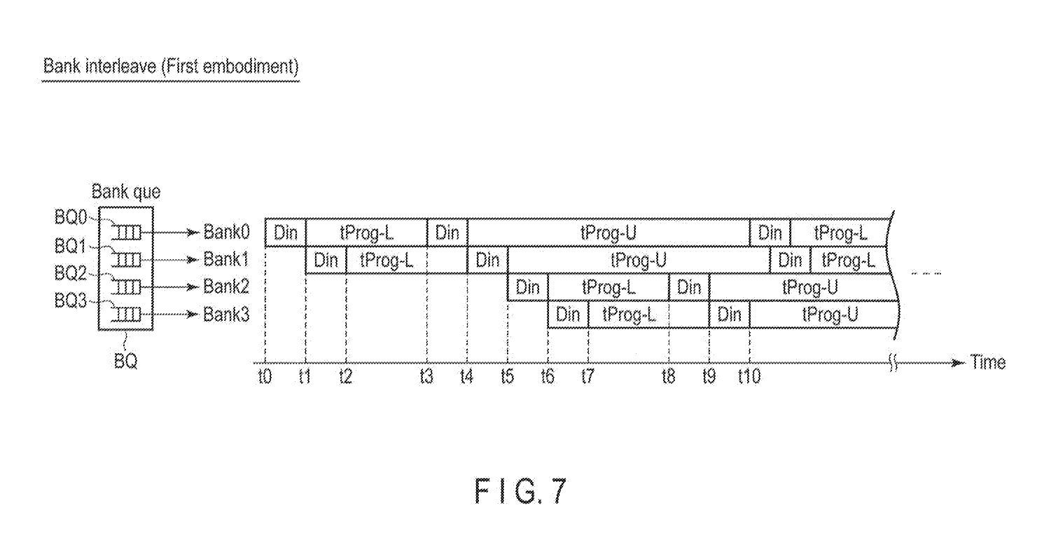

Thus, in the memory system 10 according to the first embodiment, the bank interleaving functions properly. Bank interleaving according to the first embodiment is illustrated as in FIG. 7, for example.

At time t0 in FIG. 7, write data of a lower bit which was, for example, queued from the thread TH0 or the like to the bank queue BQ0 and de-queued from the bank queue BQ0 is input to Bank 0 of the NAND memory 11 (Din). The lower bit will be described below.

At time t1, the input write data of the lower bit is written to a write-location in Bank 0 (tProg-L). Here, the NAND memory 11 according to the first embodiment is a quad memory which can store 2-bit data in a memory cell MC. Thus, one of four threshold levels consisting of the lower bit and upper bit is assigned to a memory cell MC in the NAND memory 11. Therefore, at time t1, first the data of the lower bit is written to the write-location in Bank 0.

At the same time t1, write data of a lower bit which was, for example, queued from the thread TH0 or the like to the bank queue BQ1 and de-queued from the bank queue BQ1 is input to Bank 1 of the NAND memory 11, likewise.

At time t2, the input write data of the lower bit is written to a write-location of Bank 1 (tProg-L), likewise.

At time t3, after completing the writing operation of the lower bit of Bank 0, write data of an upper bit which was de-queued from the bank queue BQ0 is input to Bank 0 of the NAND memory 11 (Din).

At time t4, the input write data of the upper bit is written to a write-location in Bank 0 (tProg-U). Here, the write time tProg-U of the upper bit is longer compared to the write time tProg-L of the lower bit (tProg-U>tProg-L).

At the same time t4, write data of the upper bit which was, for example, queued from the thread TH0 or the like to the bank queue BQ1 and de-queued from the bank queue BQ1 is input to Bank 1 of the NAND memory 11, likewise.

At time t5, write data of a lower bit which was, for example, queued from the thread TH1 or the like to the bank queue BQ2 and de-queued from the bank queue BQ2 is input to Bank 2 of the NAND memory 11 (Din), likewise.

At the same time t5, the input write data of the upper bit is written to a write-location in Bank 1 (tProg-U), likewise. Henceforth, the memory system 10 repeats the same operation likewise.

As described above, with the memory system 10 according to the first embodiment, write data is queued to the bank queue BQ in a predetermined order (BQ0→BQ1→BQ0→BQ1→BQ2→BQ3→BQ2→BQ3→ . . .). Thus, this configuration enables to dynamically evaluate the operating states and find one of the banks 0-3 with less access requests on the basis of command receiving state from the host 20, and to reduce concentration of write accesses in one of the banks 0-3. This configuration prevents write operation from concentrating in one bank, and enables the bank interleaving to function properly. As a result, the write time can be reduced. For example, the memory system 10 according to the first embodiment enables reduction of the write time to as little as ⅓ to ¼ (depending on the write data WD transmitted from the host 20) of one in the comparative example.

(2) The data capacity of the data buffer 17 can be reduced.

The data capacity of the data buffer 17 is proportionate to the time difference between the time when the receiving section 13 receives write data WD from the host 20 and the time when the received write data WD is written to the NAND memory.

As described in (1), the memory system 10 according to the first embodiment can reduce the write time as the bank interleaving functions properly. Thus, this configuration enables to reduce the time difference between the time when the receiving section 13 receives the write data WD from the host 20 and the time when the received write data WD is written to the NAND memory. Accordingly, the data capacity (data size) of the data buffer 17 can be reduced. For example, the data capacity of the data buffer 17 according to the first embodiment can be reduced to as little as ⅓ to ¼ of one in the comparative example.

In addition, the reduction of the data capacity of the data buffer 17 leads to reduction of power consumption and space occupancy by the memory controller. For example, the space that the data buffer 17 occupies in the memory controller 12 is about 10%. Therefore, merit of reducing the space occupied by the data buffer 17 is significant.

(Variation 1)

The configuration and operation of the memory system 10 are not limited to those described in the first embodiment, and may vary as necessary.

For example, the memory controller 12 may include an address translation table in which logical address LBA and corresponding physical address PBA are mapped. The memory controller 12 translates a logical address LBA transmitted from the host 20 into a predetermined physical address PBA, using the address translation table. To be more precise, the memory controller 12 may update the address translation table as the write-location information PBA0 is determined by the write-location determination unit 15.

Moreover, a predetermined RAID group may be configured with a plurality of logical blocks. The RAID group is, for example, configured astride a plurality of NAND chips configuring the NAND memory 11. According to the above configuration, for example, when a defect mode of the NAND memory such as chip loss, plane loss, or the like occurs, other NAND chips configuring the RAID group still store the lost data. Thus, even if a defect mode occurs, the data lost due to the defect mode can be recovered.

Also, a single counter CT can be used commonly for all threads TH0-TH3.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiment described herein may be made without departing from the spirit of the invention. The accompanying claims and their equivalents are intended to cover such forms or modifications as would fall within the scope and spirit of the inventions.

What is claimed is:

1. A memory device, comprising:
a nonvolatile memory unit including a plurality of banks; and
a memory controller configured to
divide write data received from a host into a plurality of data portions, and
with respect to each of the data portions, determine a bank in which said data portion is to be written and generate a write command to write said data portion to the determined bank, wherein
the memory controller determines the bank in which each of the data portions is to be written, based on the number of write commands queued for each of the banks.

2. The memory device according to claim 1, wherein
the memory controller includes a counter configured to count the number of write commands queued for each of the banks.

3. The memory device according to claim 2, wherein
the counter is configured to increment the number of write commands queued for a bank when the memory controller generates a write command to write a data portion in said bank, and decrement the number of write commands queued for a bank when a data portion has been written in said bank.

4. The memory device according to claim 1, wherein
the memory controller determines a bank for which the smallest number of write commands are queued to be the bank in which a data portion is to be written.

5. The memory device according to claim 1, wherein
the data portions includes first and second data portions, and
the memory controller determines the bank in which the first data portion is to be written, prior to determining the bank in which the second data portion is to be written.

6. The memory device according to claim 1, wherein
the memory controller determines the bank in which each of the data portions is to be written, further based on remaining capacity of each bank.

7. The memory device according to claim 6, wherein
the memory controller includes a table indicating the remaining capacity of each bank.

8. The memory device according to claim 1, wherein
the memory controller is configured to determine a plurality of candidate banks, based on remaining capacity of each bank, and determines the bank in which each of the data portions is to be written, from the candidate banks.

9. The memory device according to claim 1, wherein
the memory controller is further configured to generate parity data with respect to each of the data portions and append corresponding parity data to each of the data portions.

10. The memory device according to claim 1, wherein
the nonvolatile memory unit includes a NAND memory unit, and
each of the banks includes a plurality of multi-level memory cells.

11. A method for storing write data received from a host in a plurality of banks of a nonvolatile memory, the method comprising:
dividing the write data into a plurality of data portions; and
with respect to each of the data portions, determining a bank in which said data portion is to be written and generating a write command to write said data portion to the determined bank, wherein
the bank in which each of the data portions is to be written is determined based on the number of write commands queued for each of the banks.

12. The method according to claim 11, further comprising:
counting the number of write commands queued for each of the banks.

13. The method according to claim 12, wherein the counting includes
incrementing the number of write commands queued for a bank when a write command to write a data portion in said bank is generated, and
decrementing the number of write commands queued for a bank when a data portion has been written in said bank.

14. The method according to claim 11, wherein
the bank in which each of the data portions is to be written is determined further based on remaining capacity of each bank.

15. The method according to claim 11, further comprising:
determining a plurality of candidate banks, based on remaining capacity of each bank, wherein
the bank in which each of the data portions is to be written is determined from the candidate banks.

16. A memory device, comprising:
a nonvolatile memory unit including a plurality of banks; and
a memory controller configured to
divide write data received from a host into a plurality of data portions, and
with respect to each of the data portions, determine a bank in which said data portion is to be written and write each of the data portions in the determined bank, wherein
the memory controller determines the bank in which each of the data portions is to be written, based on a queue delay of each of the banks.

17. The memory device according to claim 16, wherein
the data portions includes first and second data portions, and
the memory controller determines the bank in which the first data portion is to be written, prior to determining the bank in which the second data portion is to be written.

18. The memory device according to claim 16, wherein
the memory controller determines the bank in which each of the data portions is to be written, also based on remaining capacity of each bank.

19. The memory device according to claim 16, wherein
the memory controller is configured to determine a plurality of candidate banks, based on remaining capacity of each bank, and determines the bank in which each of the data portions is to be written, from the candidate banks.

20. The memory device according to claim 16, wherein
the nonvolatile memory unit includes a NAND memory unit, and
each of the banks includes a plurality of multi-level memory cells.
